(19) United States
(12) Patent Application Publication
(10) Pub. No.: US 2025/0013330 A1
(43) Pub. Date: Jan. 9, 2025

(54) TOUCH DRIVING METHOD, TOUCH MODULE AND DISPLAY DEVICE

(71) Applicants: Chongqing BOE Optoelectronics Technology Co., Ltd., Chongqing (CN); BOE Technology Group Co., Ltd., Beijing (CN)

(72) Inventors: Yuansheng TANG, Beijing (CN); Bo WANG, Beijing (CN); Kangpeng DANG, Beijing (CN); Hong CHEN, Beijing (CN); Hebing XU, Beijing (CN); Xingyu PU, Beijing (CN); Xiong GUO, Beijing (CN); Zhongli LUO, Beijing (CN); Kuan LI, Beijing (CN); Cheng ZUO, Beijing (CN); Ming GAO, Beijing (CN); Yuhong SUN, Beijing (CN)

(73) Assignees: Chongqing BOE Optoelectronics Technology Co., Ltd., Chongqing (CN); BOE Technology Group Co., Ltd., Beijing (CN)

(21) Appl. No.: 18/894,012

(22) Filed: Sep. 24, 2024

Related U.S. Application Data
(63) Continuation of application No. PCT/CN2023/078660, filed on Feb. 28, 2023.

(51) Int. Cl. G06F 3/041; G06F 3/044

(52) U.S. Cl. CPC G06F 3/04166; G06F 3/044

(57) ABSTRACT

The present disclosure provides a touch driving method, a touch module and a display device, relating to the field of display technology. The display panel has M partitions, each partition includes independent touch control units, each touch control unit includes at least one common electrode block connected to each other; the driving method includes: a frame time includes a display time period and a touch time period, the display time period includes at least one display sub-time period, the touch time period includes at least one touch sub-time period; in each display sub-time period, applying a common electrode signal to all common electrode blocks; in each touch sub-time period, applying a touch driving signal to all touch units of N partitions and not applying the touch driving signal to the touch units of the remaining partitions, and sensing sense signals of the touch units of the N partitions.

### CROSS-REFERENCE TO RELATED APPLICATION

The present application is a U.S. Continuation application of International Application No. PCT/CN2023/078660, filed on Feb. 28, 2023, the content of which is incorporated by reference herein in its entirety.

### TECHNICAL FIELD

The present disclosure relates to the field of display technology, and particularly relates to a touch driving method, a touch module and a display device.

### BACKGROUND

At present, the most common technology for touch screen driving is time-division multiplexing technology, which is to divide the original screen display time unit into two parts, in which the touch screen is configured to display images in one part of the time (i.e., the display stage), and the touch screen is configured to realize the touch detection function in the other part of the time (i.e., the touch stage).

In the prior art, during actual use by the user, when there exists one hand on the touch screen and the other hand performs the actual touch, the amount of signal scanned by the actual touch area will be reduced, resulting in invalid touch.

The above information disclosed in the background technology section is only used to enhance the understanding of the background of the present disclosure, so it may include information that does not constitute prior art known to those skilled in the art.

### SUMMARY

According to a first aspect of the present disclosure, there is provided a touch driving method for a display panel, where the display panel has M partitions, M is a positive integer and M≥2, each partition includes a plurality of independent touch units, and each touch unit includes at least one common electrode block connected to each other;
the driving method includes:
a frame time includes a display time period and a touch time period, the display time period includes at least one display sub-time period, and the touch time period includes at least one touch sub-time period;
in each display sub-time period, applying a common electrode signal to all the common electrode blocks; and
in each touch sub-time period, applying a touch driving signal to all the touch units in N partitions, and not applying the touch driving signal to the touch units in remaining partitions, N is a positive integer and 1≤N<M, and sensing sensing signals of the touch units in the N partitions.

According to a second aspect of the present disclosure, there is provided a touch display module, including a display panel, where the display panel has M partitions, M is a positive integer and M≥2, each partition includes a plurality of independent touch units, each touch unit includes at least one common electrode block connected to each other, and the display panel further includes a driving signal line and a sensing signal line connected to the touch units;
a frame time of the display panel includes a display time period and a touch time period, the display time period includes at least one display sub-time period, and the touch time period includes at least one touch sub-time period;
in each display sub-time period, applying a common electrode signal to all the common electrode blocks through the driving signal line;
in each touch sub-time period, applying a touch driving signal to all the touch units in N partitions through the sensing signal line, and not applying the touch driving signal to the touch units in remaining partitions, N is a positive integer and 1≤N<M, and sensing sensing signals of the touch units in the N partitions.

According to a third aspect of the present disclosure, there is provided a display device, including the touch display module according to the second aspect.

### BRIEF DESCRIPTION OF THE DRAWINGS

The above and other features and advantages of the present disclosure will become more apparent by describing the embodiments in detail with reference to the accompanying drawings.

FIG. 1 is a schematic diagram of a touch driving signal in the related art;

FIG. 2 is a schematic diagram of a structure when only one finger contacts the touch screen in the related art;

FIG. 3 is a schematic diagram of a structure when one hand is placed on the touch screen and the other hand performs actual touch in the related art;

FIG. 4 is a measured diagram of a touch driving signal and a finger signal when only one finger contacts the touch screen in the related art;

FIG. 5 is a measured diagram of a touch driving signal and a finger signal when one hand is placed on the touch screen and the other hand performs actual touch in the related art;

FIG. 6 is a schematic diagram of a plane structure of a display panel in an embodiment of the present disclosure;

FIG. 7 is a schematic diagram of a touch driving signal in an embodiment of the present disclosure;

FIG. 8 is a schematic diagram of a touch driving signal in another embodiment of the present disclosure;

FIG. 9 is a schematic diagram of a touch driving signal in another embodiment of the present disclosure;

FIG. 10 is a schematic diagram of a touch driving signal in another embodiment of the present disclosure;

FIG. 11 is a schematic diagram of the palm and finger touch structure in an embodiment of the present disclosure;

FIG. 12 is a measured diagram of signals during touch in FIG. 9;

FIG. 13 is a schematic diagram of a structure of a touch display module in an embodiment of the present disclosure.

The reference numerals of main components in the figure are as follows:
01—common electrode block; 02—sensing unit; 10—touch unit; 11—common electrode block; 20—driving signal line; 30—sensing signal line; 100—substrate; 200—driving circuit layer; 300—pixel electrode; 400—liquid crystal layer; 500—color film substrate.

### DETAILED DESCRIPTION

Example embodiments will now be described more fully with reference to the accompanying drawings. However, example embodiments can be implemented in a variety of forms and should not be construed as limited to the examples set forth herein; rather, these embodiments are provided so that the present disclosure will be more comprehensive and complete and the concepts of the example embodiments will be fully conveyed to those skilled in the art. The described features, structures, or characteristics may be combined in one or more embodiments in any suitable manner. In the following description, many specific details are provided to provide a full understanding of the embodiments of the present disclosure.

In the figures, the thickness of regions and layers may be exaggerated for clarity. The same reference numerals in the figures represent the same or similar structures, and their detailed descriptions will be omitted.

The described features, structures, or characteristics may be combined in one or more embodiments in any suitable manner. In the following description, many specific details are provided to give a full understanding of the embodiments of the present disclosure. However, those skilled in the art will appreciate that the technical solutions of the present disclosure may be practiced without one or more of the specific details, or other methods, components, materials, etc. may be used. In other cases, well-known structures, materials, or operations are not shown or described in detail to avoid obscuring the main technical ideas of the present disclosure.

When a structure is “on” another structure, it may mean that the structure is formed integrally on the other structure, or that the structure is “directly” set on the other structure, or that the structure is “indirectly” set on the other structure through another structure.

The terms “a”, “an”, and “the” are used to indicate the existence of one or more elements/components/etc.; the terms “include” and “have” are used to indicate open-ended inclusion and mean that there may be other elements/components/etc. in addition to the listed elements/components/etc. The terms “first” and “second” are used only as labels and are not intended to limit the number of their objects.

Touch screens can be classified into Add on Mode Touch Panel, On cell Touch Panel, and In Cell Touch Panel according to their composition structure. The In Cell Touch Panel embeds the touch electrodes of the touch screen inside the liquid crystal display screen.

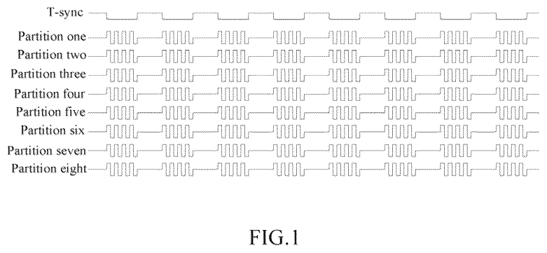

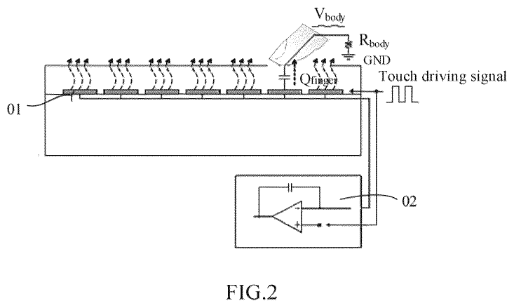

As shown in FIG. 1 and FIG. 2, in the related art, the display sub-time period and the touch sub-time period switch back and forth within one frame time (T-sync) of the In Cell Touch Panel. The common electrodes of the In Cell Touch Panel are usually divided into multiple independent common electrode blocks 01. During the display sub-time period, all common electrode blocks 01 maintain a voltage. During the touch sub-time period, the common electrodes are multiplexed as touch electrodes, and all common electrode blocks 01 are loaded with touch driving signals. Generally, the touch screen is divided into multiple zones. The sensing unit 02 scans the common electrode block 01 of only one zone at a time when performing touch sensing scanning, and scans several times until the common electrode blocks 01 of all the zones are scanned, and senses the sensing signal of the whole screen. In FIG. 1, partition one to partition eight represent different zones of the touch screen.

The sensing principle of the self-capacitive touch screen is usually as follows: in the touch sub-time period, the common electrode is multiplexed as the touch electrode and the touch driving signal is loaded. When a finger touches the touch screen, it will cause a change in the capacitance value of the corresponding position, and the touch position can be determined based on the change.

Touch sensing essentially detects the change in the amount of charge. In general, the amount of charge can be represented by the capacitance value. When the capacitance value increases, the amount of charge Q that can be stored will also increase, and vice versa.

The determining formula of capacitance is C=εS/4πkd, where ε is a constant, which is the opposing area of the capacitor plates, d is the distance between the capacitor plates, and k is the electrostatic force constant. The determining formula of capacitance is the formula that determines the size of the capacitance. The size of the capacitance is only related to ε, S, k, and d. Since ε, S, k, and d do not change when a touch occurs (a finger touches the touch screen), C does not change.

As shown in FIG. 2, when a touch occurs and only one finger touches the touch screen, only one finger is coupled with the touch signal, the user's body voltage V_{body} is small, so the potential difference V=Vₚₐₙₑₗ−V_{finger} of the in-phase touch signal between the touch screen and the finger is large. Through C-Q_{finger}/V, it can be seen that during the touch process, C between the finger and the touch screen does not change, Q_{finger} increases, and this amount of signal can be easily recognized by the sensing unit 02.

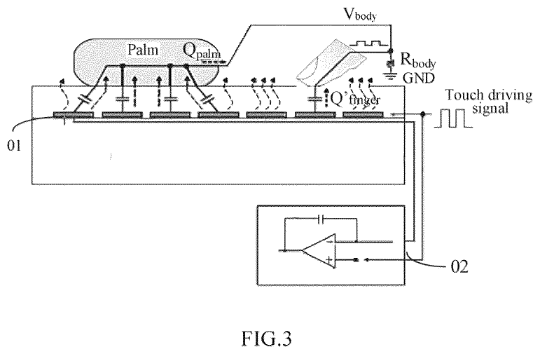

As shown in FIG. 3, when the user puts one hand on the touch screen and the other hand performs actual touch, the energy of the touch signal of the entire screen is taken away by the palm due to the large-area contact between the palm and the touch screen, and the human body is coupled to a large number of touch signals, which increases the user's body voltage V_{body}. Because the human body is a conductor, the real touch finger carries a touch signal of the same phase. When the real touch finger touches the touch screen, V_{finger} superimposed on V_{body} makes the real V′_{finger} increase, and the potential difference V=Vₚₐₙₑₗ−V′_{finger} between the finger and the touch screen becomes smaller. It can be seen from C=Q_{finger}/V that during the touch process, the C between the finger and the touch screen remains unchanged, Q_{finger} decreases, and the amount of sensing signal decreases. The real touch is mistakenly recognized as noise by the sensing unit 02 and ignored, resulting in touch disconnection.

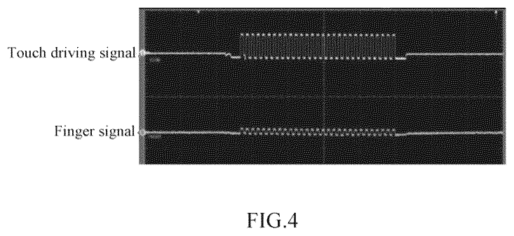

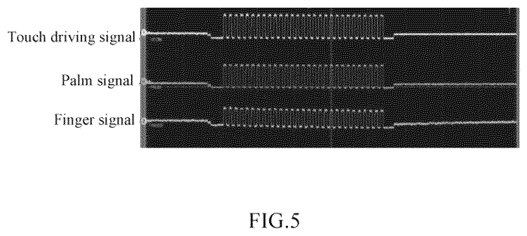

As shown in FIG. 4 and FIG. 5, FIG. 4 is a measured diagram of the touch driving signal and the finger signal when only one finger contacts the touch screen; FIG. 5 is a measured diagram of the touch driving signal and the finger signal when one hand is placed on the touch screen and the other hand performs actual touch. In the embodiments shown in FIG. 4 and FIG. 5, the loaded touch driving signals are the same. Comparing FIG. 4 and FIG. 5, it can be seen that under the same touch driving signal, the peak value of the finger signal measured when one hand is placed on the touch screen and the other hand performs actual touch is greater than the peak value of the finger signal when only one finger contacts the touch screen. In this way, it can be further explained that when one hand is placed on the touch screen and the other hand performs actual touch, the real V′_{finger} increases, and the potential difference V=Vₚₐₙₑₗ−V′_{finger} between the finger and the touch screen becomes smaller. In the figure, the curve is a voltage curve.

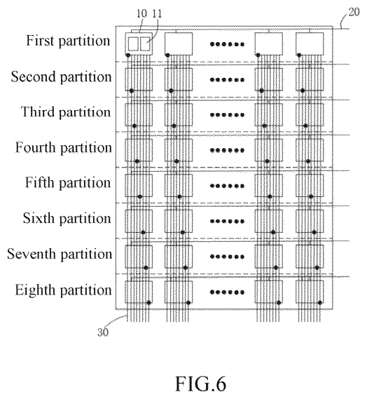

As shown in FIG. 6 to FIG. 9, the present disclosure provides a touch driving method for a display panel. The display panel has M partitions, M is a positive integer and M≥2. Each partition includes a plurality of independent common touch units 10, and each touch unit 10 includes at least one common electrode block 11 connected to each other.

The driving method includes:
one frame time includes a display time period and a touch time period, the display time period includes at least one display sub-time period, and the touch time period includes at least one touch sub-time period;
a common electrode signal is applied to all common electrode blocks 11 in each display sub-time period; and
in each touch sub-time period, a touch driving signal is applied to all touch units 10 in N partitions, and no touch driving signal is applied to the touch units 10 in the remaining partitions, N is a positive integer and 1≤N<M, and the sensing signals of the touch units 10 in the N partitions are sensed.

In the touch driving method for the display panel provided by the present disclosure, when the user places one hand on the touch screen and performs actual touch with the other hand, although the palm of the user contacts the touch screen over a large area, since only a part of the partition is loaded with the touch driving signal, only the energy of the touch signal of only a part of the partition is taken away by the palm. Compared with the full-screen application of the touch signal in the related art, the touch signal coupled to the human body in the present disclosure can be greatly reduced, which helps to solve the problem of touch disconnection.

The touch driving method for the display panel provided by the embodiment of the present disclosure is described in detail below in conjunction with the accompanying drawings:

In an embodiment of the present disclosure, the touch driving method for the display panel is provided, and the display panel can be a TFT-LCD (Thin Film Transistor Liquid Crystal Display).

As shown in FIG. 6, the display panel has M partitions, M is a positive integer and M≥2, and each partition includes a plurality of independent common electrode blocks 11. There are multiple ways to divide the display panel into zones, and the number of partitions can be multiple. For example, in one embodiment, the display panel is divided into a plurality of partitions arranged along the row direction. In another embodiment, the display panel is divided into a plurality of partitions arranged along the column direction. The number of partitions may be two, three, four, five or more. For example, in one embodiment, the display panel is divided into eight partitions arranged along the column direction. That is, the eight partitions extend along the row direction and are arranged along the column direction. Of course, the display panel may also be divided into a plurality of partitions arranged in an array, which is not specifically limited in the present disclosure.

Each partition includes a plurality of independent touch units 10. The plurality of touch units 10 are arranged in an array. The number of touch units 10 included in each partition is unlimited. For example, a plurality of touch units 10 are arranged in an array along the row direction and the column direction, and each partition includes at least one row of touch units 10. Specifically in one embodiment, each partition includes a row of touch units 10. Each touch unit 10 includes at least one common electrode block 11 connected to each other. The number of common electrode blocks 11 included in each touch unit 10 may be one, two, three or more. When the number of common electrode blocks 11 included in the touch unit 10 is greater than one, different common electrode blocks 11 are connected to each other.

The shape of the common electrode block 11 may be various, and its outer contour may be roughly rectangular or other polygonal, etc., which is not specifically limited in the present disclosure. The size of the common electrode block 11 may also be various. The display panel also includes a plurality of pixel units, each pixel unit including at least three sub-pixels. In one embodiment, each pixel unit corresponds to a common electrode block 11. The number of sub-pixels included in the pixel unit may be three or four or more. For example, the pixel unit includes a red sub-pixel, a green sub-pixel and a blue sub-pixel. For another example, the pixel unit includes a red sub-pixel, two green sub-pixels and a blue sub-pixel. For another example, the pixel unit includes a red sub-pixel, a green sub-pixel, a blue sub-pixel and a white sub-pixel. In another embodiment, each sub-pixel corresponds to a common electrode block 11.

As shown in FIG. 6 to FIG. 10, in the driving method for the display panel, one frame time includes a display time period and a touch time period in. The display time period is configured to display the picture, and the touch time period is configured to realize the touch sensing function. The display time period includes at least one display sub-time period, and the touch time period includes at least one touch sub-time period, and the display sub-time period and the touch sub-time period are alternately provided. The number of display sub-time periods can be equal or unequal to the number of touch sub-time periods. The number of display sub-time periods can be one more or one less than the number of touch sub-time periods. The number of display sub-time periods and the number of touch sub-time periods can be multiple, and the number can be adjusted according to the number of partitions contained in the display panel. In one embodiment, the display panel includes eight partitions, the number of display sub-time periods included in one frame time is eight, and the number of touch sub-time periods included in one frame time is eight, but not limited thereto.

In each display sub-time period, a common electrode signal is applied to all common electrode blocks 11. For example, when the display panel includes eight partitions, a common electrode signal is applied to all common electrode blocks 11 of the eight partitions in each display sub-time period. The common electrode signal is a constant voltage. The touch driving signal is a pulse signal, such as a square wave signal.

In each touch sub-time period, a touch driving signal is applied to all touch units 10 of N partitions, and no touch driving signal is applied to the touch units 10 of the remaining partitions, N is a positive integer and 1≤N<M, and the sensing signals of the touch units 10 of the N partitions are sensed. Further, the value of M/N can be a positive integer, for example, the value of M/N can be 2, 3, 4, 5 or 6, etc., but not limited thereto. In some examples, 1≤N≤M/2. For example, the display panel includes eight partitions, and a touch driving signal is applied to the touch unit 10 of one partition in each touch sub-time period, while the touch units 10 of the remaining partitions are not applied with the touch driving signal, and the sensing signal of the touch unit 10 of the one partition is sensed. Of course, in each touch sub-time period, a touch driving signal can also be applied to the touch units 10 of two or four partitions, and the sensing signals of the touch units 10 of the two or four partitions are sensed, while the touch units 10 of the corresponding remaining partitions are not applied with the touch driving signal.

In this case, when the user puts one hand on the touch screen and performs actual touch with the other hand, although the human palm contacts the touch screen over a large area, since only a part of the partitions are loaded with the touch driving signal, the energy of the touch signals of only a part of the partitions is taken away by the palm. Compared with the full-screen application of the touch signal in the related art, the touch signals coupled to the human body in the present disclosure can be greatly reduced, so that the user's body voltage V_{body} is reduced. When the real touch finger contacts the touch screen, the real V′_{finger} also decreases, and the potential difference V=Vₚₐₙₑₗ−V′_{finger} between the finger and the touch screen increases. It can be seen from C=Q_{finger}/V that during the touch process, the C between the finger and the touch screen remains unchanged, Q_{finger} increases, and the amount of sensing signal becomes larger, so it is easy to be sensed by the sensing unit 02, solving the problem of touch disconnection.

In some embodiments of the present disclosure, the touch time period of one frame time includes K touch sub-time periods, K is a positive integer. In the M partitions of the display panel, every arbitrary N partitions are combined to form a partition group. In the touch time period within a frame time, the touch driving signal is applied to the touch units 10 of different partition groups in different time periods, N×K=M.

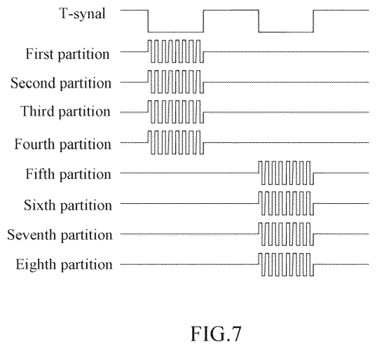

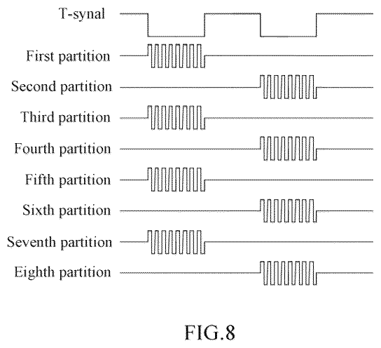

Take the display panel with eight partitions as an example, and the partitions are numbered in order as the first partition, the second partition, the third partition, the fourth partition, the fifth partition, the sixth partition, the seventh partition and the eighth partition. As shown in FIG. 7 and FIG. 8, in one embodiment, within one frame time, the touch time period includes two touch sub-time periods, and the two touch sub-time periods are numbered in order as the first touch sub-time period and the second touch sub-time period. Every arbitrary four of the eight partitions of the display panel are combined to form a partition group, and the eight partitions are combined to form two partition groups, namely the first partition group and the second partition group. Among them, the four partitions included in the first partition group can be any four partitions, which can be the first partition, the second partition, the third partition and the fourth partition, and the remaining partitions are combined to form the second partition group. Of course, the first partition group can also include the first partition, the third partition, the fifth partition and the seventh partition, and the remaining partitions are combined to form the second partition group. In the touch time period within one frame time, a touch driving signal is applied to the touch units 10 of the first partition group in the first touch sub-time period, and the sensing signals of the touch units 10 of the first partition group are sensed. In the first touch sub-time period, no touch driving signal is applied to the touch units 10 of the second partition group. A touch driving signal is applied to the touch units 10 of the second partition group in the second touch sub-time period, and the sensing signals of the touch units 10 of the second partition group are sensed. In the second touch sub-time period, no touch driving signal is applied to the touch units 10 of the first partition group.

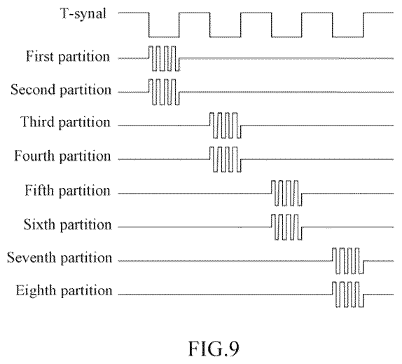

As shown in FIG. 9, in another embodiment, the touch time period within a frame time includes four touch sub-periods, and the four touch sub-periods are numbered in order as the first touch sub-period, the second touch sub-period, the third touch sub-period, and the fourth touch sub-period. Every arbitrary two partitions in the eight partitions of the display panel form a partition group, and the eight partitions are combined to form four partition groups, namely the first partition group, the second partition group, the third partition group, and the fourth partition group. Among them, the two partitions contained in the first partition group can be any two partitions, which can be the first partition and the second partition, the two partitions contained in the second partition group can be the third partition and the fourth partition, the two partitions contained in the third partition group can be the fifth partition and the sixth partition, and the two partitions contained in the fourth partition group can be the seventh partition and the eighth partition. Of course, the two partitions contained in the first partition group can be the first partition and the third partition, the two partitions contained in the second partition group can be the second partition and the fourth partition, the two partitions contained in the third partition group can be the fifth partition and the seventh partition, and the two partitions contained in the fourth partition group can be the sixth partition and the eighth partition. There can be many partitioning methods, which are not described in detail here. In the touch time period within a frame time, a touch driving signal is applied to the touch units 10 of the first partition group in the first touch sub-time period, and the sensing signals of the touch units 10 of the first partition group are sensed. In the first touch sub-time period, no touch driving signal is applied to the touch units 10 of the remaining partition groups. A touch driving signal is applied to the touch units 10 of the second partition group in the second touch sub-time period, and the sensing signals of the touch units 10 of the second partition group are sensed. In the second touch sub-time period, no touch drive unit signal is applied to the touch units 10 of the remaining partition groups. A touch driving signal is applied to the touch units 10 of the third partition group in the third touch sub-time period, and the sensing signals of the touch units 10 of the third partition group are sensed. In the third touch sub-time period, no touch drive unit signal is applied to the touch units 10 of the remaining partition groups. A touch driving signal is applied to the touch units 10 of the fourth partition group in the fourth touch sub-time period, and the sensing signals of the touch units 10 of the fourth partition group are sensed. In the fourth touch sub-time period, no touch driving signal is applied to the touch units 10 of the remaining partition groups.

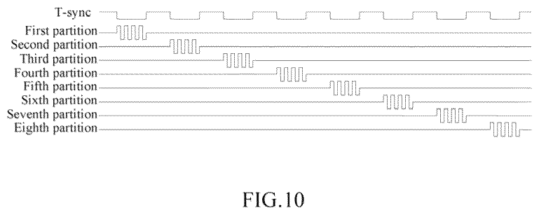

As shown in FIG. 10, in another embodiment, the touch time period in one frame time includes eight touch sub-time periods, and the eight touch sub-time periods are numbered in order as the first touch sub-time period, the second touch sub-time period, the third touch sub-time period, the fourth touch sub-time period, the fifth touch sub-time period, the sixth touch sub-time period, the seventh touch sub-time period and the eighth touch sub-time period. One of the eight partitions of the display panel forms a partition group, and the eight partitions form eight partition groups, namely the first partition group, the second partition group, the third partition group, the fourth partition group, the fifth partition group, the sixth partition group, the seventh partition group and the eighth partition group, and each partition forms a partition group. In the touch time period in one frame time, a touch driving signal is applied to the touch units 10 of the first partition group, and the sensing signals of the touch units 10 of the first partition group are sensed in the first touch sub-time period. In the first touch sub-time period, no touch driving signal is applied to the touch units 10 of the remaining partition groups. A touch driving signal is applied to the touch units 10 of the second partition group, and the sensing signals of the touch units 10 of the second partition group are sensed in the second touch sub-time period. In the second touch sub-time period, no touch driving signal is applied to the touch units 10 of the remaining partition groups. A touch driving signal is applied to the touch units 10 of the third partition group, and the sensing signal of the touch units 10 of the third partition group are sensed in the third touch sub-time period. In the third touch sub-time period, no touch driving signal is applied to the touch units 10 of the remaining partition groups. A touch driving signal is applied to the touch units 10 of the fourth partition group, and the sensing signals of the touch units 10 of the fourth partition group are sensed in the fourth touch sub-time period. In the fourth touch sub-time period, no touch driving signal is applied to the touch units 10 of the remaining partition groups. A touch driving signal is applied to the touch units 10 of the fifth partition group, and the sensing signals of the touch units 10 of the fifth partition group are sensed in the fifth touch sub-time period. In the fifth touch sub-time period, no touch driving signal is applied to the touch units 10 of the remaining partition groups. A touch driving signal is applied to the touch units 10 of the sixth partition group, and the sensing signals of the touch units 10 of the sixth partition group are sensed in the sixth touch sub-time period. In the sixth touch sub-time period, no touch driving signal is applied to the touch units 10 of the remaining partition groups. A touch driving signal is applied to the touch units 10 of the seventh partition group, and the sensing signals of the touch units 10 of the seventh partition group are sensed in the seventh touch sub-time period. In the seventh touch sub-time period, no touch driving signal is applied to the touch units 10 of the remaining partition groups. A touch driving signal is applied to the touch units 10 of the eighth partition group, and the sensing signals of the touch units 10 of the eighth partition group are sensed in the eighth touch sub-time period. In the eighth touch sub-time period, no touch driving signal is applied to the touch units 10 of the remaining partition groups.

As shown in FIGS. 6, 7, 9 and 10, further, the M partitions of the display panel are arranged along the first direction; every N partitions are combined along the first direction to form a partition group; in the touch time period within a frame time, the touch driving signal is applied to the touch units 10 of different partition groups in turn along the first direction in time periods. The first direction can be a column direction, that is, multiple partitions of the display panel are arranged along the column direction. In the touch time period within a frame time, the touch driving signal is sequentially applied to different touch units 10 in the column direction in time periods. Take the above display panel including eight partitions, and one partition forms a partition group as an example. Then, the touch driving signal is applied to the first partition in the first touch sub-time period, the touch driving signal is applied to the second partition in the second touch sub-time period, the touch driving signal is applied to the third partition in the third touch sub-time period, the touch driving signal is applied to the fourth partition in the fourth touch sub-time period, the touch driving signal is applied to the fifth partition in the fifth touch sub-time period, the touch driving signal is applied to the sixth partition in the sixth touch sub-time period, the touch driving signal is applied to the seventh partition in the seventh touch sub-time period, and the touch driving signal is applied to the eighth partition in the eighth touch sub-time period. When the touch driving signal is applied to a partition, the sensing signals of the touch units 10 of the partition are sensed.

In this embodiment, when the user places one hand on the touch screen and performs actual touch with the other hand, only one partition is loaded with the touch driving signal each time, so only the energy of the touch signal of the partition is taken away by the palm. Compared with the full-screen touch signal in the related art, the touch signal coupled to the human body in this embodiment can be greatly reduced, so that the user's body voltage V_{body} is greatly reduced. When the real touch finger contacts the touch screen, the real V′ finger is also reduced accordingly, and the potential difference V=Vₚₐₙₑₗ−V′_{finger} between the finger and the touch screen becomes larger. It can be seen from C=Q_{finger}/V that during the touch process, the C between the finger and the touch screen remains unchanged, Q_{finger} becomes larger, and the sensing signal amount becomes larger, so that it is easy to be sensed by the sensing unit 02, solving the problem of touch disconnection.

The touch driving method disclosed in this disclosure is described in detail with a specific touch example.

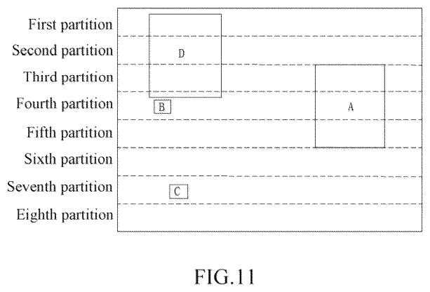

As shown in FIG. 10 and FIG. 11, the display panel includes eight partitions arranged along the column direction, and the eight partitions are numbered in order as the first partition, the second partition, the third partition, the fourth partition, the fifth partition, the sixth partition, the seventh partition and the eighth partition. One frame time includes eight display sub-time periods and eight touch sub-time periods. In this touch example, the user places one palm on the touch screen, occupying area A, and actually touches with the other hand, and the actual touch points are B and C. Among them, area A roughly occupies the third partition, the fourth partition and the fifth partition. The actual touch point B is located in the fourth partition, and C is located in the seventh partition.

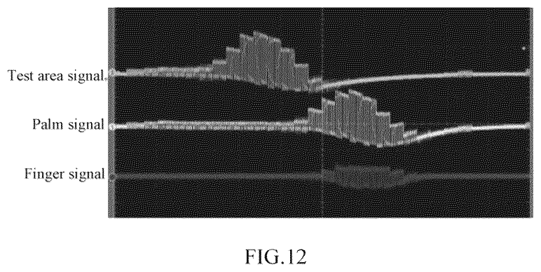

As shown in FIG. 12, when the touch driving signal is applied to the first partition, the positions of the actual touch points B and A areas are far away from the first partition, the coupling signals at the two positions are low, so the waveform amplitudes of the finger signal and the palm signal reflected in the measured waveform are small. In FIG. 11, each signal curve on the waveform has eight steps, each step corresponds to a partition, which are, from left to right, the first partition to the eighth partition.

When the touch driving signal is applied row by row to the third partition where area A is located, the signal at the palm begins to reach a peak value, while the actual touch point B has an increased amplitude due to the close distance, but has not yet reached the signal required for touch.

When the touch driving signal is applied to the fourth partition, the actual touch point B is in the same area as the palm. The palm currently only receives capacitive coupling from the fourth partition, and the amplitude of the same phase signal conducted to the finger through the human body is reduced. Therefore, compared with the full-screen driving in the related technology, the actual touch point B has a reduced V_{body}, and the real V′_{finger} is also reduced, and the potential difference V=Vₚₐₙₑₗ−V′_{finger} between the finger and the touch screen becomes larger. It can be seen from C=Q_{finger}/V that during the touch process, the C between the finger and the touch screen remains unchanged, and Q_{finger} becomes larger, then the sensing signal amount becomes larger, so that it is easy to be sensed by the sensing unit 02, and this signal will not be identified as noise for processing, solving the problem of touch disconnection.

When the touch driving signal is applied to the fifth partition, the palm is still in the area, and the actual touch point B is close to the palm, so the situation here is the same as the third partition. Then the scan continues, the scanning area becomes farther from the palm and the actual touch point B, and the amplitude gradually decreases.

When the touch driving signal is applied to the seventh partition where the actual touch point C is located, the actual touch point C is in a different area from the area A. The in-phase signal at the finger caused by the palm has been greatly reduced. Since the finger and the touch driving signal are in different phases, and the potential difference V between the palm and the finger increases, it can be seen from C=Q_{finger}/V that the C between the human body and the touch screen remains unchanged, Q_{finger} increases, and the sensing signal amount increases.

When the touch driving signal is applied to the eighth partition, the actual touch point C and the A area are far away from the eighth partition, and the coupling signal at the two positions is low, so the waveform amplitudes of the finger signal and the palm signal reflected in the measured waveform are reduced.

In addition, during the measurement process, the display panel also sets a test area D, which can be placed with copper foil. Since the test area D is above the real touch and the palm, its waveform position is forward compared to the two. The test to the test area D is similar to the test to the palm, so its waveform is similar to that of the palm.

In the present disclosure, the touch sensing principle is generally as follows: in the touch time period, the common electrode is multiplexed as the touch electrode and the touch driving signal is loaded. When a finger touches the touch screen, it will cause a change in the capacitance value at the corresponding position, and the touch position can be determined according to the change. That is, the touch position is determined by sensing the self-capacitance change signal of the touch unit 10 in the touch time period.

As shown in FIGS. 6 to 10, the present disclosure also provides a touch display module, including a display panel. The display panel has M partitions, M is a positive integer and M≥2. Each partition includes a plurality of independent touch units 10, and each touch unit 10 includes at least one common electrode block 11 connected to each other. The display panel also includes a driving signal line 20 and a sensing signal line 30 connected to the touch unit 10. One frame time of the display panel includes a display time period and a touch time period. The display time period includes at least one display sub-time period, and the touch time period includes at least one touch sub-time period. In each display sub-time period, a common electrode signal is applied to all common electrode blocks 11 through the driving signal line 20. In each touch sub-time period, a touch driving signal is applied to all touch units 10 in N partitions through the sensing signal line 30, and no touch driving signal is applied to the touch units 10 in the remaining partitions, N is a positive integer and 1≤N<M, and the sensing signals of the touch units 10 in the N partitions are sensed.

Further, the value of M/N can be a positive integer, such as the value of M/N can be 2, 3, 4, 5 or 6, etc., but is not limited thereto. Preferably, 1≤N≤M/2. In each touch sub-time period, a common electrode signal can be applied to the touch units 10 in the remaining partitions.

The structure of the common electrode block 11 included in the display panel can refer to the above description and will not be repeated in detail. The driving signal line 20 is connected to the touch unit 10 for transmitting a common electrode signal or a touch driving signal. The sensing signal line 30 is connected to the touch unit 10 for transmitting a sensing signal. Further, the touch display module also includes a touch display chip. That is, the touch chip and the display chip are integrated into a single chip, and the driving signal line 20 and the sensing signal line 30 can be connected to the touch display chip.

In some embodiments of the present disclosure, the touch time period within a frame time of the touch display module includes K touch sub-time periods, and K is a positive integer. In the M partitions of the display panel, every arbitrary N partitions are combined to form a partition group. In the touch time period within a frame time, the touch driving signal is applied to the touch units 10 of different partition groups in time periods, and N×K=M. Specifically in one embodiment, the M partitions of the display panel are arranged along the first direction. Every N partitions are combined along the first direction to form a partition group. In the touch time period within a frame time, the touch driving signal is applied to the touch units 10 of different partition groups in time periods in sequence along the first direction.

The display panel also includes a plurality of pixel units, and each pixel unit includes at least three sub-pixels. In one embodiment, each pixel unit corresponds to a common electrode block 11. The number of sub-pixels included in the pixel unit can be three or four or more. For example, the pixel unit includes a red sub-pixel, a green sub-pixel and a blue sub-pixel. For another example, the pixel unit includes a red sub-pixel, two green sub-pixels and a blue sub-pixel. For another example, the pixel unit includes a red sub-pixel, a green sub-pixel, a blue sub-pixel and a white sub-pixel. In another embodiment, each sub-pixel corresponds to a common electrode block 11.

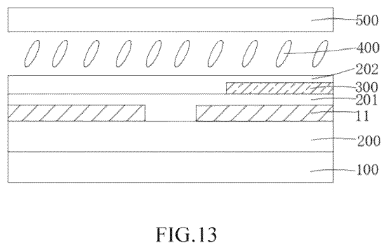

As shown in FIG. 13, the display panel is a multi-layer stacked structure, and the display panel includes an array substrate and a color filter substrate 500 which are arranged oppositely and a liquid crystal layer 400 located between the array substrate and the color filter substrate 500. The array substrate includes the above-mentioned common electrode block 11. Specifically, the array substrate may include a substrate 100, a driving circuit layer 200 disposed on one side of the substrate 100, and a common electrode block 11 disposed on a side of the driving circuit layer 200 away from the substrate 100. The driving circuit layer 200 may include devices such as thin film transistors TFTs for forming pixel circuits, etc. The array substrate also includes a pixel electrode 300, and the pixel electrode 300 is disposed on a side of the common electrode block 11 away from the substrate 100. A multi-dimensional electric field is generated between the pixel electrode 300 and the common electrode, and the multi-dimensional electric field is configured to drive the liquid crystal in the liquid crystal layer 400 to deflect, thereby controlling the light emission of the liquid crystal display panel in the pixel area. A first insulating layer 201 is provided between the pixel electrode 300 and the common electrode block 11, and a second insulating layer 202 is also provided on the side of the pixel electrode 300 away from the substrate 100.

The present disclosure also provides a display device, including a touch display module. The touch display module can be the touch display module of any of the above-mentioned embodiments, and its specific structure and beneficial effects can refer to the embodiments of the touch display module above, which will not be repeated here. The display device of the present disclosure can be an electronic device such as a mobile phone, a tablet computer, a television, etc., which will not be listed one by one here.

It should be noted that although the steps of the method in the present disclosure are described in a specific order in the accompanying drawings, this does not require or imply that these steps must be performed in this specific order, or that all the steps shown must be performed to achieve the desired results. Additionally or alternatively, some steps may be omitted, multiple steps may be combined into one step for execution, and/or one step may be decomposed into multiple steps for execution, etc., which shall all be considered as part of the present disclosure.

It should be understood that the present disclosure does not limit its application to the detailed structure and arrangement of the components proposed in this specification. The present disclosure can have other embodiments and can be implemented and executed in a variety of ways. The aforementioned variations and modifications fall within the scope of the present disclosure. It should be understood that the present disclosure disclosed and defined in this specification extends to all alternative combinations of two or more individual features mentioned or evident in the text and/or the drawings. All of these different combinations constitute multiple alternative aspects of the present disclosure. The embodiments of this specification illustrate the best known way to implement the present disclosure and will enable those skilled in the art to utilize the present disclosure.

What is claimed is:

1. A touch driving method for a display panel, wherein the display panel has M partitions, M is a positive integer and M≥2, each partition comprises a plurality of independent touch units, and each touch unit comprises at least one common electrode block connected to each other; a frame time comprises a display time period and a touch time period, the display time period comprises at least one display sub-time period, and the touch time period comprises at least one touch sub-time period; the driving method comprises:
in each display sub-time period, applying a common electrode signal to all the common electrode blocks; and
in each touch sub-time period, applying a touch driving signal to all the touch units in N partitions, and not applying the touch driving signal to the touch units in remaining partitions, N is a positive integer and 1≤N<M, and sensing sensing signals of the touch units in the N partitions.

2. The touch driving method for the display panel according to claim 1, wherein the display sub-time period and the touch sub-time period are arranged alternately;
the touch time period comprises K touch sub-time periods, and K is a positive integer;
in the M partitions of the display panel, every arbitrary N partitions are combined to form a partition group; and
in the touch time period within a frame time, the touch driving signal is applied to the touch units of different partition groups in time periods, N×K=M.

3. The touch driving method for the display panel according to claim 2, wherein the M partitions of the display panel are arranged along a first direction;
every N partitions are combined along the first direction to form a partition group; and
in the touch time period within a frame time, the touch driving signal is applied to the touch units of different partition groups in time periods in sequence along the first direction.

4. The touch driving method for the display panel according to claim 1, wherein in each touch sub-time period, the common electrode signal is applied to the touch units of the remaining partitions.

5. The touch driving method for the display panel according to claim 1, wherein 1≤N≤M/2.

6. The touch driving method for the display panel according to claim 1, wherein the touch driving signal is a pulse signal.

7. The touch driving method for the display panel according to claim 1, wherein a touch position is determined by sensing a self-capacitance change signal of the touch units in the touch sub-time period.

8. The touch driving method for the display panel according to claim 1, wherein the display panel has a plurality of pixel units arranged in an array, each of the pixel units comprises at least three sub-pixels, and each of the pixel units corresponds to one of the common electrode blocks.

9. A touch display module, comprising a display panel, wherein the display panel has M partitions, M is a positive integer and M≥2, each partition comprises a plurality of independent touch units, each touch unit comprises at least one common electrode block connected to each other, and the display panel further comprises a driving signal line and a sensing signal line connected to the touch units;
a frame time of the display panel comprises a display time period and a touch time period, the display time period comprises at least one display sub-time period, and the touch time period comprises at least one touch sub-time period;
in each display sub-time period, applying a common electrode signal to all the common electrode blocks through the driving signal line; and
in each touch sub-time period, applying a touch driving signal to all the touch units in N partitions through the sensing signal line, and not applying the touch driving signal to the touch units in remaining partitions, N is a positive integer and 1≤N<M, and sensing sensing signals of the touch units in the N partitions.

10. The touch display module according to claim 9, wherein the display sub-time period and the touch sub-time period are arranged alternately;
the touch time period comprises K touch sub-time periods, K is a positive integer;
in the M partitions of the display panel, every arbitrary N partitions are combined to form a partition group; and
in the touch time period within a frame time, the touch driving signal is applied to the touch units of different partition groups in time periods, N×K=M.

11. The touch display module according to claim 10, wherein the M partitions of the display panel are arranged along a first direction;
every N partitions are combined along the first direction to form a partition group; and
in the touch time period within a frame time, the touch driving signal is applied to the touch units of different partition groups in time periods in sequence along the first direction.

12. The touch display module according to claim 9, wherein in each touch sub-time period, the common electrode signal is applied to the touch units of the remaining partitions.

13. The touch display module according to claim 9, wherein 1≤N≤M/2.

14. The touch display module according to claim 9, wherein the display panel has a plurality of pixel units arranged in an array, each of the pixel units comprises at least three sub-pixels, and each of the pixel units corresponds to one of the common electrode blocks.

15. A display device, comprising a touch display module, the touch display module comprising a display panel, wherein the display panel has M partitions, M is a positive integer and M≥2, each partition comprises a plurality of independent touch units, each touch unit comprises at least one common electrode block connected to each other, and the display panel further comprises a driving signal line and a sensing signal line connected to the touch units;
a frame time of the display panel comprises a display time period and a touch time period, the display time period comprises at least one display sub-time period, and the touch time period comprises at least one touch sub-time period;
in each display sub-time period, applying a common electrode signal to all the common electrode blocks through the driving signal line; and
in each touch sub-time period, applying a touch driving signal to all the touch units in N partitions through the sensing signal line, and not applying the touch driving signal to the touch units in remaining partitions, N is a positive integer and 1≤N<M, and sensing sensing signals of the touch units in the N partitions.

16. The display device according to claim 15, wherein the display sub-time period and the touch sub-time period are arranged alternately;
the touch time period comprises K touch sub-time periods, K is a positive integer;
in the M partitions of the display panel, every arbitrary N partitions are combined to form a partition group; and
in the touch time period within a frame time, the touch driving signal is applied to the touch units of different partition groups in time periods, N×K=M.

17. The display device according to claim 16, wherein the M partitions of the display panel are arranged along a first direction;
every N partitions are combined along the first direction to form a partition group; and
in the touch time period within a frame time, the touch driving signal is applied to the touch units of different partition groups in time periods in sequence along the first direction.

18. The display device according to claim 15, wherein in each touch sub-time period, the common electrode signal is applied to the touch units of the remaining partitions.

19. The display device according to claim 15, wherein 1≤N≤M/2.

20. The display device according to claim 15, wherein the display panel has a plurality of pixel units arranged in an array, each of the pixel units comprises at least three sub-pixels, and each of the pixel units corresponds to one of the common electrode blocks.
